(19) United States
(12) Patent Application Publication
(10) Pub. No.: US 2011/0239809 A1
(43) Pub. Date: Oct. 6, 2011

(54) LENGTH-ADJUSTABLE STEERING ACTUATION UNIT FOR A MOTOR VEHICLE WITH A SUPPORT AND A STEERING COLUMN

(76) Inventors: Wilfried Beneker, Leichlingen (DE); Burkhard Becker, Solingen (DE); Thomas Arndt, Monheim (DE)

(21) Appl. No.: 13/163,583

(22) Filed: Jun. 17, 2011

Related U.S. Application Data
(63) Continuation of application No. PCT/EP2009/009359, filed on Dec. 18, 2009.

(30) Foreign Application Priority Data
Dec. 19, 2008 (DE) 10 2008 063 902.8
Dec. 19, 2008 (DE) 10 2008 063 903.6
Aug. 20, 2009 (DE) 10 2009 028 757.4

(51) Int. Cl. B62D 1/18; B62D 1/19

(52) U.S. Cl. 74/493

(57) ABSTRACT

A length-adjustable steering actuation unit for a motor vehicle includes a) a support having means for attaching the support to the motor vehicle, b) a steering column rotatable about a longitudinal axis and comprising an upper steering tube and a lower steering tube, and c) an adjusting device for adjusting the distance of the upper steering tube relative to the lower steering tube and the support. An element is provided between the two steering tubes. The element is deformable in the case of an accident. The element shortens in the event of an accident. The total length of the upper steering tube and the lower steering tube is shorter after an accident than prior to the accident.

### CROSS-REFERENCE TO RELATED APPLICATIONS

This application is a continuation of International Patent Application No. PCT/EP2009/009359, filed Dec. 18, 2009, designating the United States, and claims priority under 35 U.S.C. §119(a)-(d) to German Application No. DE 10 2008 063 902.8, filed Dec. 19, 2008, German Application No. DE 10 2008 063 903.6, filed Dec. 19, 2008, and German Application No. DE 10 2009 028 757.4, filed Aug. 20, 2009, the contents of all of which are hereby incorporated by reference in their entirety as part of the present disclosure.

### FIELD OF THE INVENTION

The invention relates to a length-adjustable steering actuation unit for a motor vehicle, comprising a) a support to be attached to the motor vehicle, b) a steering column rotatable about a longitudinal axis and comprises an upper steering tube and a lower steering tube, and c) an adjusting device for adjusting the distance of the upper steering tube relative to the lower steering tube and the support. The length adjustment is motor-driven.

### BACKGROUND OF THE INVENTION

A motor-operated steering column adjusting device for a length-adjustable steering actuation unit is known from DE 10 2007 042 737 A1. This known steering column-adjusting device comprises a support to be attached to the vehicle and a jacket tube. The latter is adjustable in its longitudinal direction and, additionally, also in its inclination relative to the support. An appropriate drive is also respectively provided for this purpose.

Such steering column adjusting devices enable convenient adaptation to the respective wishes and requirements of the user. Due to the motor-operated configuration, a steering wheel is convenient to adjust; it can also be controlled via a memory. Generally, electric motors are provided as the motors. A length-adjustable steering column is known from US 2008/0229866 A1.

In the known steering column-adjusting device, the jacket tube is designed to accommodate the steering column. The jacket tube itself adds to the weight of the arrangement, requires a certain effort in its production and installation, and occupies space within the structure. This is a disadvantage. The goal is a steering actuation unit that works without such a jacket tube, if possible.

Moreover, a requirement with regard to the steering column-adjusting device is that, in the case of an accident, the steering column can shorten while absorbing energy. If the driver hits the steering wheel in the event of an accident, the steering wheel is thus supposed to be axially moveable in the direction of the steering tubes, with some type of compression preferably occurring in the area of the steering tubes.

### SUMMARY OF THE INVENTION

Based thereon, it is an object of the invention to propose a steering actuation unit for a motor vehicle that has beneficial characteristics in accidents and enables a specific shortening in the case of loads caused by accidents.

The object is achieved by a motor-operated length-adjustable steering actuation unit for a motor vehicle, comprising a) a support to be attached to the motor vehicle, b) a steering column that is rotatable about a longitudinal axis and comprises an upper steering tube and a lower steering tube, and c) an adjusting device for adjusting the distance of the upper steering tube relative to the lower steering tube and the support, wherein an element that is deformable in the case of an accident is provided between the two steering tubes, which shortens in the event of an accident, so that the total length of the upper steering tube and the lower steering tube after an accident is shorter than prior to an accident.

This steering actuation unit works with as few components as possible. It has a significantly lower weight than steering actuation units produced in accordance with the prior art. A jacket tube can be dispensed with. In particular, the upper steering tube can exhibit a high bending stiffness. In the cylinder portion, it has the approximate diameter of a human fist, and may be hollow. In order to save weight, it can be manufactured from light metal.

The two steering tubes are coaxially interconnected through a non-rotatable slide connection. The longitudinal adjustment of the upper steering tube, and therefore of the steering wheel to be attached thereto, relative to the lower steering tube is thus accomplished. The lower steering tube does not move in the direction of the longitudinal axis relative to the support. The lower steering tube is able to rotate relative to the support.

In one embodiment, the support comprises a swivel bridge that is connected to a main body of the support so as to be pivotable about a support axis, the support axis being parallel to the y-axis. The swivel bridge is connected to the holder so as to be pivotable about a pivot axis, the pivot axis also being parallel to the y-axis, and a rotary bearing is connected to the support so as to be pivotable about a lower axis extending parallel to the y-direction.

The two steering tubes are interconnected through a sliding coupling. It comprises a first non-circular coupling section and a second non-circular coupling section that are in engagement with each other in an area of overlap. This engagement takes place over a distance that at least corresponds to the distance of the longitudinal adjustment of the steering actuation unit.

A threaded adjustment unit may be provided for adjusting the distance between the two steering tubes. For this purpose, the upper steering tube, or a part connected therewith, and/or the lower steering tube, or a part connected therewith, has a first threaded portion. This is in engagement with the second threaded portion. The second threaded portion may be formed on a component disposed in such a way that the second threaded portion is rotatable about the longitudinal axis, but not moveable in the direction of the longitudinal axis. In one embodiment, the component is an adjusting tube grasping around the lower steering tube. By rotating the adjusting tube about its axis, which coincides with the longitudinal axis, the upper steering tube can be adjusted in the longitudinal direction. In this case, the adjusting tube is stationary during the rotational movement. An electric motor, for example, which rotates the adjusting tube, is allocated to the adjusting tube.

The first threaded portion can be provided as an external thread on the upper steering tube and/or on a casing tube. The upper steering tube is either rigidly connected to the casing tube, or rotatably connected thereto, so that it is axially connected with the casing tube but rotatable relative thereto. The casing tube shortens in the event of an accident. This shortening is achieved by at least one of the following processes: 1) The casing tube deforms in the transitional area to the upper steering tube, e.g., it widens at this place; 2) the casing tube shortens; it is configured, for example, as a grid; and/or 3) the casing tube deforms in the area of transition to the lower steering tube or the adjusting tube. In some embodiments, at least two processes occur, while in other embodiments, all three processes may be provided.

In some embodiments, a deformation of the hollow tube in the area of transition to the lower steering tube or the adjusting tube occurs. For this purpose, the casing tube may be connected to a nut forming the internal thread. The shortening process may then occur between the casing tube and this nut. The nut is configured accordingly for this purpose. It has, for example, a rolled contour that causes the casing tube to widen like a trumpet during compression, and/or it has cutting edges with an additional or without an additional screw-on thread; due to the cutting edges, the casing tube is slotted during compression. Other configurations are possible.

The first threaded portion may be formed as an internal thread on this casing tube or the nut. Accordingly, the second threaded portion is in that case an external thread.

In another embodiment, the steering actuation unit comprises a steering column support. In order for it to always be at the same distance from the upper end of the upper steering tube, and thus from the steering wheel, a displacing device is provided that connects the steering column support with the holder. In the longitudinal direction, this displacing device can pass through at least the same displacing distance as the distance of the longitudinal adjustment. The displacing device may comprise a first displacing part connected to the holder and a second displacing part connected to the steering column support. These displacing parts may be, but need not be, configured as tubes. They may be formed, for example, as a half-tube shell that extends only over about 180° about the longitudinal axis. They may comprise a longitudinal guide. For example, a projection may be provided in one part that latches into a longitudinally extending elongated hole of the other part. An anti-rotation lock may be provided between the two parts.

In another embodiment, at least one further part is configured as a deformable element in addition to the casing tube. A deformable element is understood to be a component that shortens in the axial direction when subjected to loads caused by an accident. It can be configured, for example, as a latticed tube. Suitable designs are part of the prior art.

Other advantages and features of the invention become apparent from the other claims as well as from the following description of exemplary embodiments of the invention, which shall be understood not to be limiting and which will be explained below with reference to the drawings.

### BRIEF DESCRIPTION OF THE DRAWINGS

FIG. 1 is a left rear perspective view of a steering actuation unit;

FIG. 2 is a bottom view of the steering actuation unit of FIG. 1;

FIG. 3 is a sectional view taken along section line of FIG. 2;

FIG. 4 is a right rear perspective view of the steering actuation unit of FIG. 1;

FIG. 5 is a sectional view taken along section line V-V of FIG. 3;

FIG. 6 is an enlargement of area VI of FIG. 3;

FIG. 7 is a sectional view taken along section line VII-VII of FIG. 6;

FIG. 8 is a sectional view taken along section line VIII-VIII of FIG. 6;

FIG. 9 is a sectional view taken along section line IX-IX of FIG. 6;

FIG. 10 an enlargement of the left part of FIG. 6;

FIG. 11 is a sectional view of a casing tube with a nut and a lower steering tube in a configuration similar to FIG. 3;

FIG. 12 is a sectional view of an embodiment of a nut different from the nut shown in FIG. 11;

FIG. 13 is a perspective view of the nut of FIG. 12;

FIG. 14 is a sectional view of another embodiment of a nut;

FIG. 15 is a perspective view of the nut of FIG. 14;

FIG. 16 is a perspective view of another embodiment of a nut similar to the nut of FIG. 15 but with threading on the outside; and

FIG. 17 is a sectional view of another embodiment of the present invention with a spindle drive.

### DETAILED DESCRIPTION OF EMBODIMENTS OF THE INVENTION

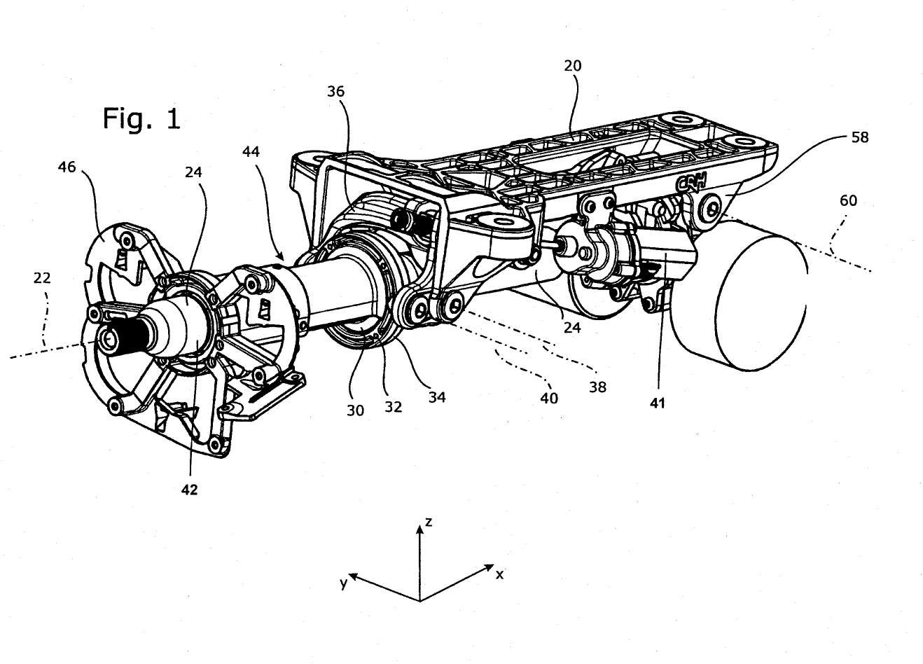

The length-adjustable steering actuation unit is suitable for assembly into a motor vehicle. The coordinates of the latter are drawn in into FIG. 1. The x direction is the normal direction of travel straight on, the y direction is in the plane of travel and transverse to the normal direction of movement, the z direction extends vertically upwards.

The steering actuation unit comprises a support 20 that is usually attached to the vehicle underneath a dashboard (not shown). Suitable devices are provided for this purpose. The support 20 is located in the interior of the motor vehicle. Moreover, the steering actuating device has a steering column that is rotatable about a longitudinal axis 22 and comprises an upper steering tube 24 and a lower steering tube 26. These tubes have a joint area of overlap 29. Within the overlap area 29, the lower steering tube 26 is pushed into the upper steering tube 24. In each case, the cross section is non-circular so that a non-rotatable but longitudinally displaceable connection is obtained that is provided at least over the entire distance 31 of the length-adjusting range. A length of the overlap area greater than the length adjustment range may be provided, for example a length greater by at least 50%.

In the exemplary embodiment, the lower steering tube 26 is configured as a solid tube. The upper steering tube 24 is a hollow tube having larger dimensions. In a cylinder portion 28, which in the longitudinal direction extends at least over the distance of length adjustment, the external diameter may be between 35 and 60 mm, and may be greater than 45 mm. In this cylinder portion 28, the surface 42 of the upper steering tube 24 is configured precisely and smoothly. The cylinder portion 28 is grasped by a slide ring 30. It may be made from plastic. In some embodiments, it has a bias. Any play in the radial direction is eliminated as far as possible. The slide ring 30 is able to slide in the longitudinal direction over the cylinder portion 28. A bearing 32 is located radially outside of the slide ring 30. It has an inner part connected to the slide ring 30 and an outer part fixed on a holder 34. This holder 34 has an annular shape. A swivel bridge 36 engages it laterally. The swivel bridge 36 is connected to a main body of the support 20 so as to be pivotable about a support axis 38. The holder 34 and the bearing 32 can be moved together about a pivot axis 40. The swivel bridge 36 is connected to the holder 34 so as to be moveable about the pivot axis 40. Both axes 38, 40 are parallel to the y direction. A motor-operated longitudinal adjustment device 41 is disposed between the swivel bridge 36 and the main body of the support 20 and enables a pivoting movement. An inclination adjustment of the two steering tubes 24, 26 relative to the support 20 is thus possible.

In another embodiment, which is not shown, the cylinder portion 28 is non-circular and the slide ring 30 is adapted accordingly with regard to its shape. The slide ring 30 slides along the cylinder portion in the direction of the longitudinal axis with as little play as possible, but is unable to rotate about the longitudinal axis 22. The task of the guide or cylinder portion 28 and the slide ring 30 is providing a longitudinal guidance in the direction of the longitudinal axis 22. In the configuration of the guiding portion as a cylinder portion 28 shown herein, it is possible to dispense with the bearing and to assign the rotary movement to the slide ring 30.

A displacing device 44 extends rearwards, towards the free end of the upper steering tube 24, from the holder 34. It has two half-shells disposed one behind the other in the longitudinal direction 22; in this regard, particular reference is made to FIG. 5. The two half-shells grasp over the upper steering tube 24 from above. Via a longitudinal guide extending in the direction of the longitudinal axis 22, they are displaceable over a distance that at least corresponds to the distance of the longitudinal adjustment. The two parts are not rotatable relative to each other. The first part is fixed on the holder 34. A steering column support 46 of known constructional design is attached to the second part. It is ensured by the displacing device 44 that the steering column support 46 cannot be pivoted about the longitudinal axis 22. The steering column support 46 is uncoupled from a rotary movement of the steering column but can be moved in the direction of the longitudinal axis 22. It can be connected in this manner with a steering wheel (not shown) that is rotatable relative to the steering column support 46, and always has the same distance from the steering wheel.

The upper steering tube 24 has a first threaded portion 48. In the specific exemplary embodiment, this is formed on a casing tube 50 as an internal thread. The casing tube 50 is firmly connected to the upper steering tube 24 and ends together with the upper steering tube 24 at the same area outside the lower steering tube 26. It forms an annular gap together with the steering tube 24. An adjusting tube 52, which has a second threaded portion 54 in engagement with the first threaded portion 48, engages into this annular gap. This adjusting tube 52 grasps around the lower steering tube 26. It is fixed relative to the support 20 in the direction of the longitudinal axis 22; it can be rotated about the longitudinal axis 22. A motor-operated rotary drive 56 is provided for this purpose. When the adjusting tube 52 is rotated, the upper steering tube 24 moves forwards or backwards in the direction of the longitudinal axis 22, depending on the direction of rotation.

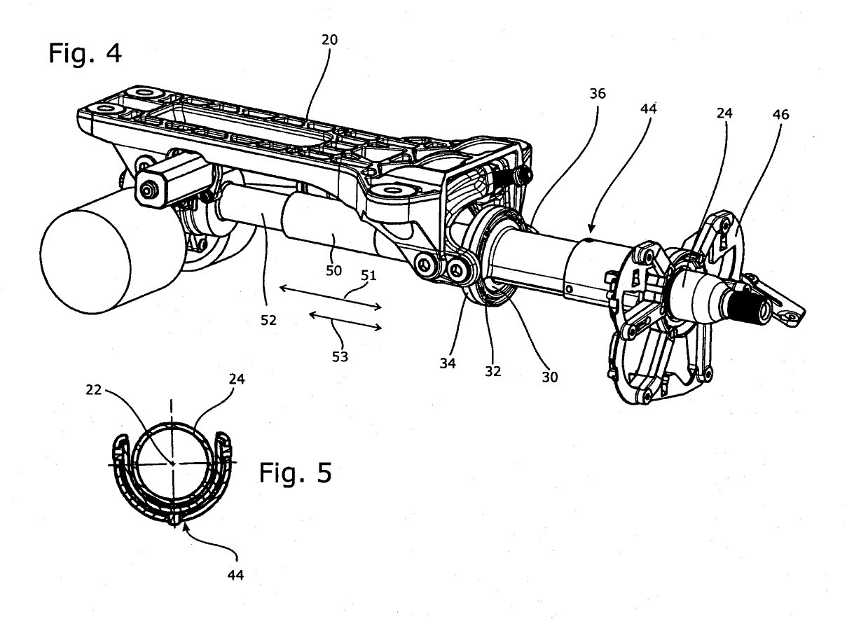

The casing tube 50 shortens in the event of an accident. In FIG. 4, an arrow 51 shows the normal length of the casing tube 50; an arrow 53 shows the length shortened due to an accident.

In one embodiment, the casing tube 50 and/or the adjusting tube 52 are configured as a safety element. This is configured in such a way that the respective tube 50 or 52 is deformed under an axial load. Corresponding constructions are known from the prior art, for example, a configuration as a latticed tube. Deformation of at least one of the tubes 50 or 52 occurs when an axial compression force is exerted on the steering column, that is, if a person hits the steering wheel, for example. The upper steering tube 24 is then able to move towards the lower steering tube 26 along the overlapping portion, and the steering column thus becomes shorter. The overlapping portion is designed to be appropriately long so that even in the case of a longitudinal adjustment of the upper steering tube 24 into its foremost position, which is closest to the lower steering tube 26, there is still enough space that is not used for longitudinal adjustment, but is for the compression of the steering column caused by an accident. Thus, the overlapping portion has a dual use.

In this respect, the invention also relates to a steering actuation unit for a motor vehicle, comprising a support to be attached to the motor vehicle and a steering column that is rotatable about a longitudinal axis 22 and comprises an upper steering tube 24 and a lower steering tube 26, wherein these steering tubes 24, 26 have a joint area of overlap, for which purpose the upper steering tube has an axially extending, first non-circular coupling area and the lower steering tube 26 has an axially extending, second non-circular coupling area, and these coupling areas are in engagement with each other in the area of the overlap, and an element that is deformable in the case of an accident is provided between the two steering tubes 24, 26, which shortens in the event of an accident, so that the total length of the upper steering tube 24 and the lower steering tube 26 after an accident is shorter than prior to an accident.

The embodiment just described can also be used for steering actuation units that enable only a longitudinal adjustment of the steering wheel. With regard to weight, it has great advantages over the steering actuation units known so far in the prior art.

The lower steering tube 26 is rotatably mounted in its lower area. There, or close to a rotary mounting 58, it is connected to the support 20 so as to be pivotable about a tilting axis 60. This will be discussed in more detail below.

A housing 62 is located at the lower end portion of the lower steering tube 26. Between this housing 62 and the lower steering tube 26, bearing means 64 are provided that are in this case configured as ball bearings. A gear unit 66 is disposed in the housing 62. An end piece 68 that is coaxial with the lower steering tube 26 and rotatable relative thereto about the longitudinal axis 22 is axially put on the lower end portion of the lower steering tube 26. This end piece 68 can be considered a part of the lower steering tube 26. This end piece 68 is also rotatably mounted in the housing 62 by means of a ball bearing.

The gear unit 66 is composed of two interconnected wobble stages; they are connected in series. Such wobble stages are known from the prior art, reference is made only by way of example to DE 30 13 304 C2, EP 03 40 118 A1 and EP 02 74 331 A1. Each wobble stage is composed of an internally toothed external gear and an externally toothed internal gear. In some embodiments, the two wobble stages are constructionally identical.

A first external gear 70 is non-rotatably connected to the lower end of the lower steering tube 26. A first internal gear 72 is located therein. This is non-rotatably connected with a second internal gear 74 via a bridge 75. The bridge comprises a jacket 77 that is coaxial with the internal gears 72, 74. An externally toothed ring 76 is in non-rotatable engagement with this bridge 75 and is free from play.

This toothed ring 76 has an eccentric internal bore 79 adapted to the jacket 77 and accommodating it with an exact fit. The toothed ring 76 is central to the two external gears 70, 82. The toothed ring 76 is in toothed engagement with a worm 78 or the like, which is driven by an adjusting motor 80.

The second internal gear 74 is encompassed by a second external gear 82. This is non-rotatably connected to the end piece 68. The external gears 70, 82 are central to the longitudinal axis 22, the two internal gears 72, 74 are eccentric. The external gears 70, 82 are in the same rotary position. Due to their rigid connection, the internal gears 72, 74 are in the same rotary position. The second external gear 82 is encompassed by a toothed servo ring 84 and is non-rotatably connected therewith; this servo ring 84 is in engagement with a gear wheel 86 driven by a servomotor 88.

All of the above-described parts are disposable within the body of a motor vehicle. They are not located close to a steering gear, for example a toothed rack of the steering system, but protected within the space in which the passengers are also normally located. Thus, encapsulating the motors 56, 80, 88 against splashing water, high-pressure cleaning water and the like is not necessary. In the assembled state, the gear unit 66 is located above the foot levers for the brake etc., in particular in the passenger compartment.

In the illustrated embodiment, two motors 80 and 88 are shown, but it is possible to provide only one motor, e.g., only the servomotor 88, or only the adjusting motor 80.

The function of the adjusting motor 80 will now be described. Without the action of the adjusting motor 80, the lower steering tube 26, in the case of a steering movement, will rotate at the same angular velocity as the end piece 68. In the process, the unit comprised of the two internal gear wheels 72, 74 moves at the same angular velocity in an eccentric distance about the longitudinal axis 22. The unit comprised of the two internal gears 72, 74 does not rotate during its rotary movement about the longitudinal axis 22. In other words, the same teeth of the external gear 70 and 82, respectively, and the internal gear 72 and 74, respectively, stay in engagement.

If, however, the arrangement comprised of the two internal gears 72, 74 is rotated by means of the adjusting motor 80 into the one or the other direction of rotation, the two internal gears 72, 74 roll in the respective external gear 70 and 82, respectively. Thus, the end piece 68 rotates at a different angular velocity from the lower steering tube 26. Thus, a transmission or reduction of the angular velocity is achieved with which the lower steering tube 26 and thus a steering wheel are being rotated. It is thus possible to make steering deflections dependent upon speed. At high speeds, for example, a larger turning angle on the steering wheel is required in order to move the steered front wheels in a certain steering angle than at lower speeds.

A servo function, that is, a support for the torque required for steering, is carried out by the servomotor 88. Thus, a user only needs to exert a part of the torque onto the steering wheel that is required for a steering movement without the servo function. Such servo functions are known in principle; reference is made only by way of example to US 2003/0209382 A1, EP 1 065 132 A1 and DE 198 11 977 A1.

In the prior art, however, these known servo-supported steering systems, also referred to as EPAS (EPAS=electric power assisted steering), are not located and protected in the interior, but close to the front axle and therefore require separate protection. All three of the above-mentioned references show servo arrangements disposed outside the passenger compartment.

The invention is advantageous in that the gear unit 66 can be configured in an extremely small and lightweight manner. In this context, reference is made to the dimensions that can be gathered directly from the drawing. The diameter of the external gears is between 40 to 45 mm.

In the embodiment shown, many combinations are possible. On the one hand, a steering support can only take place if the servomotor 88 is driven accordingly. The adjusting motor 80 is not required in this case. On the other hand, only a variable transmission within the steering column can be achieved if the adjusting motor 80 is driven accordingly. Both functions can also be provided at the same time.

As is apparent from the exemplary embodiment shown, the two motors 80, 88 are disposed at opposite sides of the housing 62. Their output shafts extend in the y direction. The first toothed parts connected therewith, that is, the worm 78 or the gear wheel 86, thus rotate about an axis that is parallel to the y-axis. The two parts are closely adjacent; their radial distance is less than the external diameter of such a gear unit part. Bearing means are provided; in this connection, reference is made to the ball bearings that are illustrated.

Compared with the designs according to the prior art known so far, the configuration shown permits a weight reduction of more than 50%. In particular, the servo-supported steering system is configured in a weight-saving manner because relatively small gears are being used. The arrangement with the adjusting motor 80 for a variable transmission of the steering deflection is also configured in an extremely space-saving and weight-saving manner. The wobble mechanisms used have a high strength and can be configured to be relatively small.

Additional parts are still required for the apparatus to function. For example, a control circuit (not shown) is necessary for both motors 80 and 88, which may be according to the known circuits. It receives input-side control information on the speed of the vehicle, the movement of the steering tubes 24, 26 and thus of the steering wheel, etc.

FIG. 8 shows a play compensation mechanism. Here, the toothed ring 76 is comprised of two parts; it comprises an outer ring and an eccentric part 90. The bridge 75 is encompassed by the eccentric part 90, which is substantially annular, but has a projection pointing outwards, which may be located where the greatest eccentricity is provided. The outer ring of the toothed ring 76 has an eccentric inner hole 92 that has a recess that fits the projection exactly. The eccentric part 90 is non-rotatably connected to the outer ring via the lateral shoulders of the projection or of the recess. Between the bottom of the recess and the opposite free end of the projection, a strong spring 94 is disposed that biases the projection in such a way that it is biased towards the longitudinal axis 22. The overall result is freedom from play.

FIG. 8 moreover shows how the above-described de-wobbling between the toothed ring 76 and the bridge 75 occurs. Because the bridge 75 wobbles between the two internal gears 72, 74 in the case of movement, a de-wobbling is required.

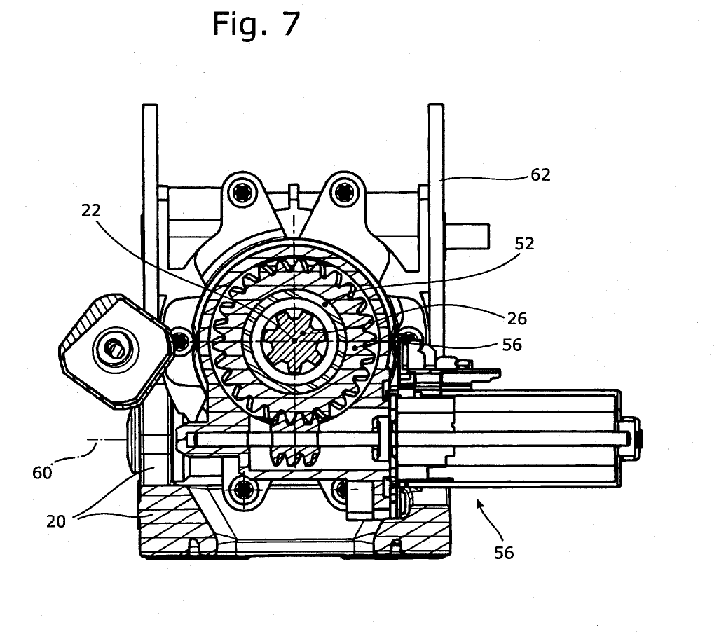

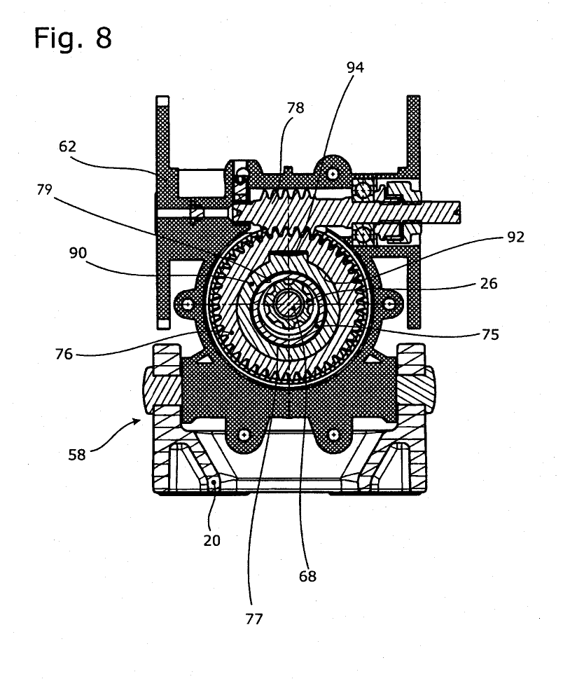

FIG. 7 shows details of the motor-operated drive for the longitudinal adjustment of the two steering tube 24, 26 relative to each other. The adjusting tube 52 is connected to a gear rim 92. A drive worm, which is part of the rotary drive 56, is in engagement therewith. A rotation of the upper steering tube 24 causes a change of the length of the steering column. In order to prevent a change in length from occurring upon a movement of the steering wheel, and thus, a rotation of the upper steering tube 24, it is proposed in a first alternative to activate the rotary drive 56 in such a way that the adjusting tube 52 rotates at the same angular velocity as the upper steering tube 24. In a second alternative, it is proposed to provide a switchable coupling system between the adjusting tube 52 and the upper steering tube 24. This switchable coupling system normally connects the adjusting tube 52 to the upper steering tube 24. Whenever a longitudinal adjustment of the two steering tubes 24, 26 relative to each other is supposed to take place, that is, if the rotary drive 56 is activated, the coupling system is first released and then, the state in which a longitudinal adjustment is possible is provided. Both alternatives require the detection of a steering movement on the steering wheel. A suitable sensor, e.g., a rotary encoder, is provided for this purpose. Such a sensor is allocated to the control circuit for the servomotor 88 in order to be able to detect a steering deflection and thus a servo-support.

If none of the two above-mentioned alternatives or an equivalent arrangement is provided, the distance for the longitudinal adjustment in both directions is limited by suitable stops in such a way that a sufficient residual distance remains in the longitudinal direction 22 for the change in length caused by the steering movements.

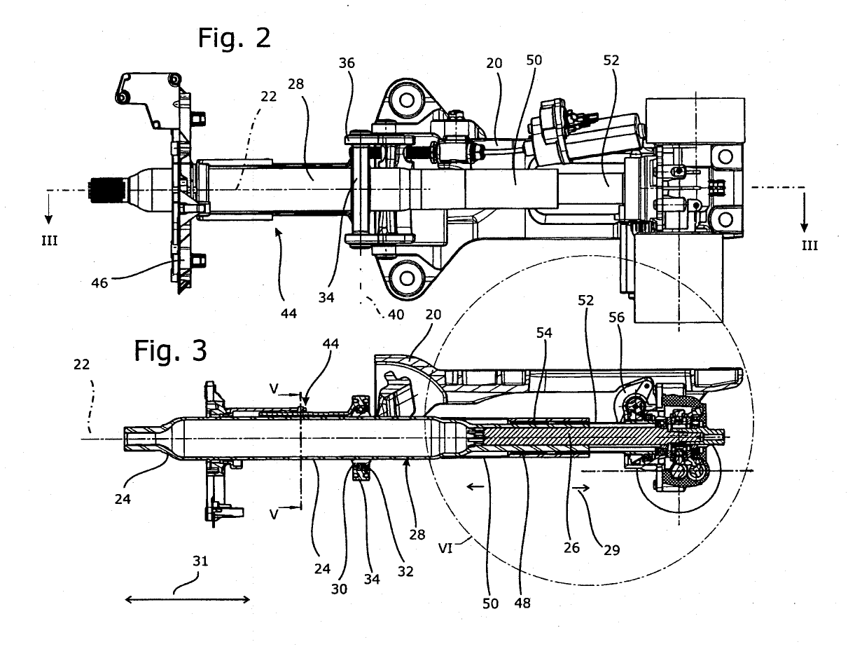

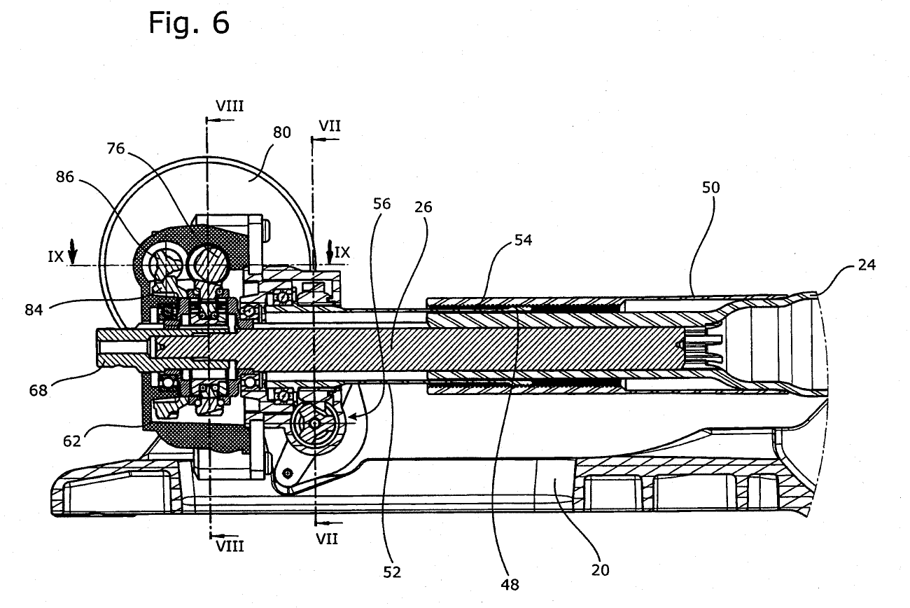

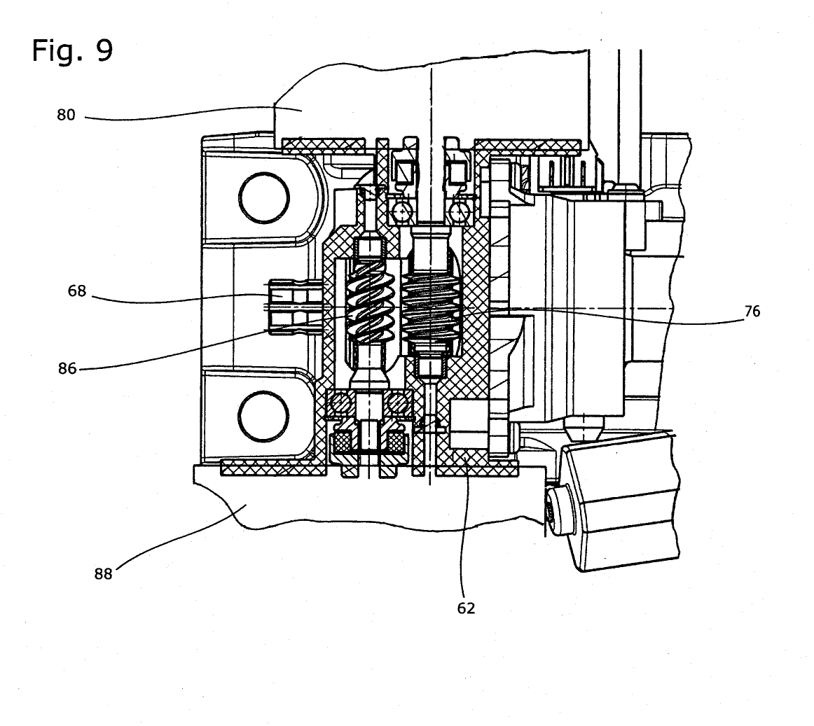

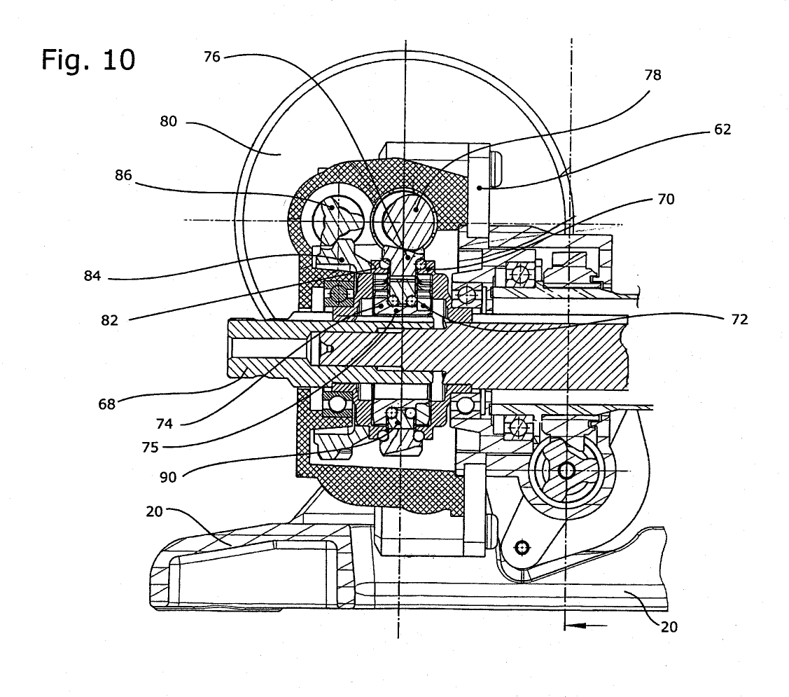

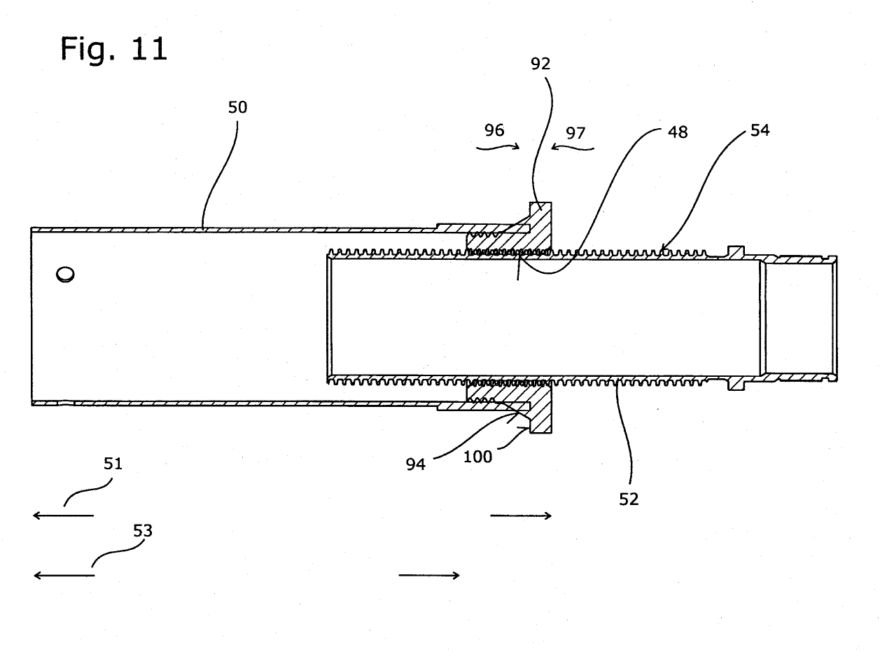

For a structure similar to FIGS. 1 to 10, in particular FIG. 6, FIG. 11 shows an alternative embodiment for the casing tube 50, which is now connected to a nut 92 forming the internal thread. This nut is in engagement with an outer thread provided on the adjusting tube 52. In an alternative embodiment, no adjusting tube 52 is provided, but the component that in FIG. 11 constitutes the adjusting tube 52 is the lower steering tube. In this case, the casing tube 50 is connected to the upper steering tube 24 so as to be rotatable but axially fixed at its front end, which in FIG. 11 is the left end.

The nut 92 has an inclined surface 94 located on a surface of a cone. In the event of an accident, a compression occurs as it is shown by the arrows 96, 97. In the process, the right end of the casing tube 50 is pressed up the inclined surface 54 and deforms; on the whole, the casing tube 50 shortens. The nuts 92 may have one stop surface each that forms a limitation of the axial travel of the casing tube 50.

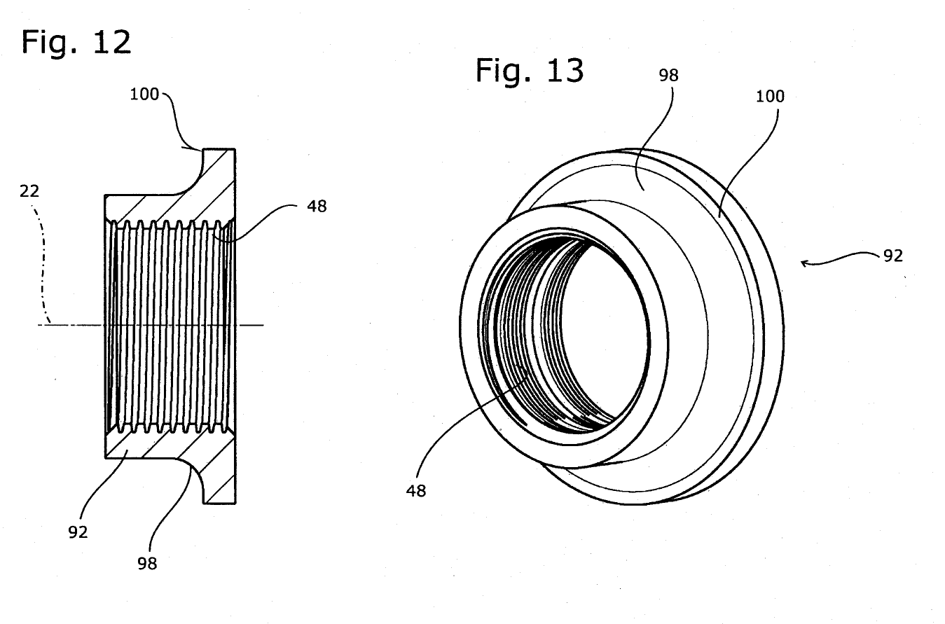

FIGS. 12 to 16 show an alternative configuration for the nut. In the configuration according to FIG. 12, the nut 92 does not have an inclined surface, but a tulip-like expanded portion, also referred to as trumpet, in place of the inclined surface 94. It has a similar effect to the inclined surface 94; it causes the compressed casing tube to open up at the right end portion.

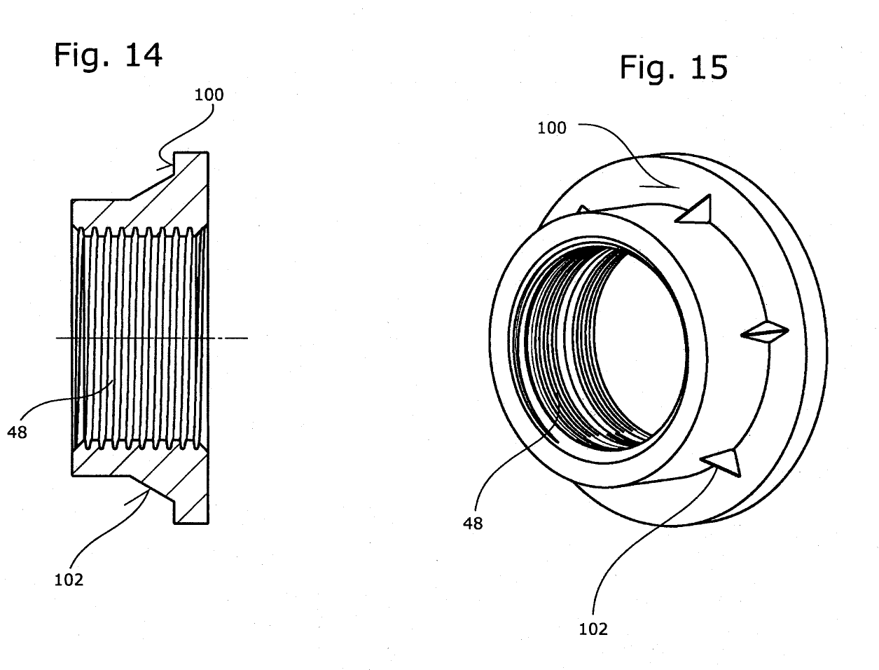

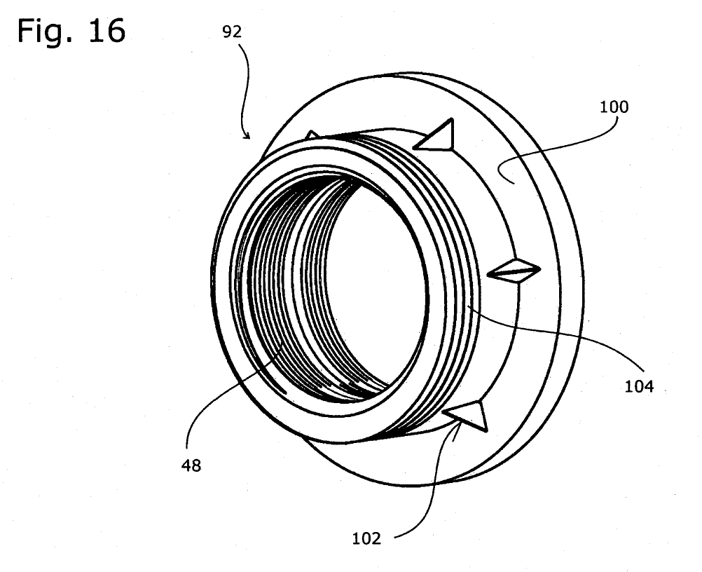

In the configuration according to the FIGS. 14 and 15, the nut 92 comprises no inclined surface 94 and no expanded portion 98, but a cylindrical area. Cutting edges 102 rise therefrom at an angle of about 10° to 45°, for example 20°; they transition into the stop surface 100. In the event of an accident, the cutting edges 102 cause the right end portion of the casing tube 50 to tear open and effect a compression against the stop surface 100.

The embodiment according to FIG. 16 differs from the embodiment according to FIGS. 14 and 15 by the fact that a screw-on thread is additionally provided in front of the cutting edges 102 on the outer jacket of the nut 92. A connection with the inner surface of the casing tube 50 takes place there. A stronger cohesion between the casing tube 50 and the nut 92 is thus achieved.

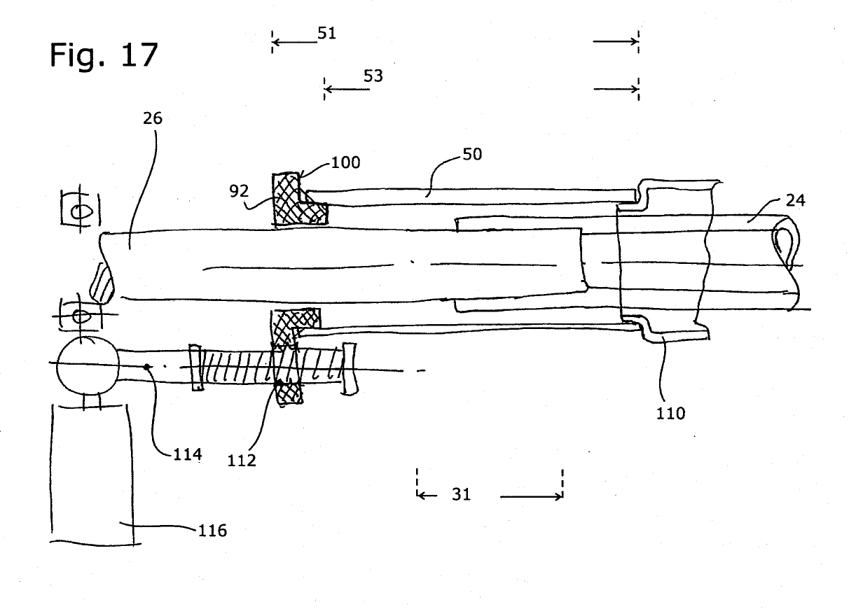

FIG. 17 shows another embodiment. Here, a jacket tube 110 is provided that sheathes the upper steering tube 24 as is known. The casing tube 50 is firmly connected to this jacket tube 110, both axially as well as in the circumferential direction. Such a jacket tube 110 does not have to be provided; the casing tube 50 can also be connected to the upper steering tube 24.

The casing tube 50 is connected to a ring 92. Whereas the part 92 was a nut in the preceding exemplary embodiments, it now does not have any internal thread and is therefore referred to as a ring 92. This ring 92 according to the exemplary embodiment according to FIG. 17 can be configured as it is also shown in the exemplary embodiments according to the FIGS. 11 to 16, however, in each case without the internal thread 48. Instead of the internal thread of the preceding exemplary embodiments, the ring 92 has a sliding surface by which the ring 92 rests on an outer surface of the lower steering tube 26. The outer surfaces of the lower steering tube 26 and the inner surface of the ring 92 are configured accordingly in order to enable a sliding movement at least over the length of the distance 31. Configuring the ring 92 to be relatively long in the axial direction prevents any tilting movement of the ring 92 relative to the lower steering tube 26. Such tilting movements can occur in practical operation, but in particular also in the event of an accident.

In contrast to the preceding exemplary embodiments, a decentralized bore 112 with an internal thread is now formed in the ring 92. A spindle 114 driven by a motor 116 reaches into this bore 112. The motor is axially fixed relative to the lower steering tube 26. This arrangement, comprised of a spindle 114 and a motor 116, is generally known. Constructions are used therefor as they have been in filed patent applications, including those filed by the applicant, and as they are used in motor vehicles, for example, for adjusting motor vehicle seats, for example, the height adjusting mechanism. An adjustment over at least the distance 31 is possible through the spindle 114, whose threaded portion is depicted in FIG. 17. The spindle 114 substantially extends parallel to the longitudinal axis (22). The jacket tube 110 takes over the task of the parts of the displacing device 44 with regard to fixing the steering column support 46 in the direction of rotation. The jacket tube 110 axially moves together with the upper steering tube 24.

The applicant reserves the right to combine any features and partial features of the claims in any way, and/or any partial features from the description, also in any way, with one another. The upper steering tube 24 is also referred to as the upper steering column portion; the lower steering tube 26 is also referred to as the lower steering column portion. The invention is also suitable for steering actuation units with a jacket tube.

An accident may be a crash. A crash is defined in that a security element of the vehicle, especially the airbags, is triggered.

As should be recognized by those of ordinary skill in the pertinent art based on the teachings herein, numerous changes and modifications may be made to the above-described and other embodiments of the present invention without departing from its scope as defined in the appended claims. Accordingly, this detailed description of embodiments is to be taken in an illustrative, as opposed to a limiting, sense.

What is claimed is:

1. A length-adjustable steering actuation unit for a motor vehicle, comprising a) a support having means for attaching the support to the motor vehicle; b) a steering column rotatable about a longitudinal axis thereof and comprising an upper steering tube and a lower steering tube; c) an adjusting device configured to adjust the distance of the upper steering tube relative to the lower steering tube and the support; and d) a deformable element disposed between the upper steering tube and the lower steering tube, wherein the deformable element deforms and shortens in the case of an accident such that a total length of the upper steering tube and the lower steering tube is shorter after the accident than prior to the accident.

2. A steering actuation unit as defined in claim 1, wherein the deformable element comprises at least one of a casing tube and an adjusting tube.

3. A steering actuation unit as defined in claim 2, wherein the deformable element comprises the casing tube, the casing tube is connected to a nut, and the total length of the casing tube and the nut shortens in the event of an accident.

4. A steering actuation unit as defined in claim 1, wherein the distance of the upper steering tube relative to the lower steering tube is adjustable over a longitudinal adjustment distance, the upper steering tube and the lower steering tube overlap in a joint area of overlap, the upper steering tube has an axially extending, first non-circular coupling area, and the lower steering tube has an axially extending, second non-circular coupling area in engagement with the first non-circular coupling area in the joint area of overlap and extending over at least the longitudinal adjustment distance.

5. A steering actuation unit as defined in claim 1, further comprising a casing tube disposed between the upper steering tube and the lower steering tube, one of the upper steering tube and the casing tube has a first threaded portion, and the adjusting device has an adjusting tube grasping around the lower steering tube and a second threaded portion in engagement with the first threaded portion.

6. A steering actuation unit as defined in claim 5, wherein the casing tube comprises the first threaded portion.

7. A steering actuation unit as defined in claim 6, wherein the first threaded portion defines an internal thread and the second threaded portion defines an external thread.

8. A steering actuation unit as defined in claim 1, further comprising an adjusting tube disposed between the upper steering tube and the lower steering tube and an electromotive rotary drive configured to rotate the adjusting tube about the longitudinal axis.

9. A steering actuation unit as defined in claim 1, further comprising a spindle extending substantially parallel to the longitudinal axis and a casing tube disposed between the upper steering tube and the lower steering tube and connected to a ring, wherein at least one of the casing tube and the ring comprises a threaded portion in engagement with the spindle.

10. A steering actuation unit as defined in claim 1, wherein the support further comprises a main body, a swivel bridge connected to the main body and pivotable about both a support axis that is parallel to the y-axis and a pivot axis that is parallel to the y-axis, and a holder connected to the swivel bridge, wherein a lower end portion of the lower steering tube is supported in the support and is pivotable about a tilting axis.

11. A steering actuation unit as defined in claim 1, wherein the deformable element comprises at least one of an additional tube and an adjusting tube and changes its axial dimensions due to a load resulting from an accident.

12. A steering actuation unit as defined in claim 1, further comprising a casing tube disposed between the upper steering tube and the lower steering tube and having a first threaded portion, wherein the lower steering tube comprises a second threaded portion in engagement with the first threaded portion.

13. A steering actuation unit as defined in claim 12, wherein the first threaded portion defines an internal thread and the second threaded portion defines an external thread.
